(19) United States
(12) Patent Application Publication
(10) Pub. No.: US 2004/0139622 A1
(43) Pub. Date: Jul. 22, 2004

(54) Drawing tool

(76) Inventor: James W. Vlk, Redmond, WA (US)

Correspondence Address: James W. Vlk, 16208 NE 109th Street, Redmond, WA, 98052, US

(21) Appl. No.: 10/346,454

(22) Filed: Jan. 17, 2003

(51) Int. Cl. B43L 7/00

(52) U.S. Cl. 33/483

(57) ABSTRACT

A drawing tool in the form of an angle bar with first and second legs having parallel edges and outer faces forming a dihedral angle greater than 180°, and with a handle attached to the first outer face. The handle and the first edge are preferably disposed in a plane that is perpendicular to the second edge.

### TECHNICAL FIELD

My invention is a simple tool that a person with impaired dexterity can conveniently grasp for use as a ruler, straightedge or cutting guide.

### BACKGROUND OF THE INVENTION

Traditional rulers and straightedges are difficult for a person with impaired dexterity, for example due to arthritis, to grasp and manipulate.

Artists often elevate one edge of a flat or triangular ruler to draw lines. The artist supports the ruler with his or her fingers and then draws a line with a drawing implement. The ruler is subject to slippage as there is little contact with the drawing surface to provide stability. The entire length of the ruler cannot be used due to the lost edge where the ruler is grasped and no method of self-support is available to prevent the ruler from accidental dropping on the artwork where smearing or other damage may occur. Vertical lines are especially difficult to draw due the awkward position of the hand holding the ruler.

### SUMMARY OF THE INVENTION

A drawing tool in the form of an angle bar with first and second legs having parallel edges and outer faces forming a dihedral angle greater than 180°, and with a handle attached to the first outer face. The handle and the first edge are preferably disposed in a plane that is perpendicular to the second edge.

### BRIEF DESCRIPTION OF THE DRAWINGS

FIG. 1 is a perspective view of a representative drawing tool of my invention.

FIG. 2A is cross-sectional view showing use of the drawing tool as a ruler.

FIG. 2B is cross-sectional view showing use of the drawing tool as an artist's straightedge.

### DETAILED DESCRIPTION OF THE INVENTION

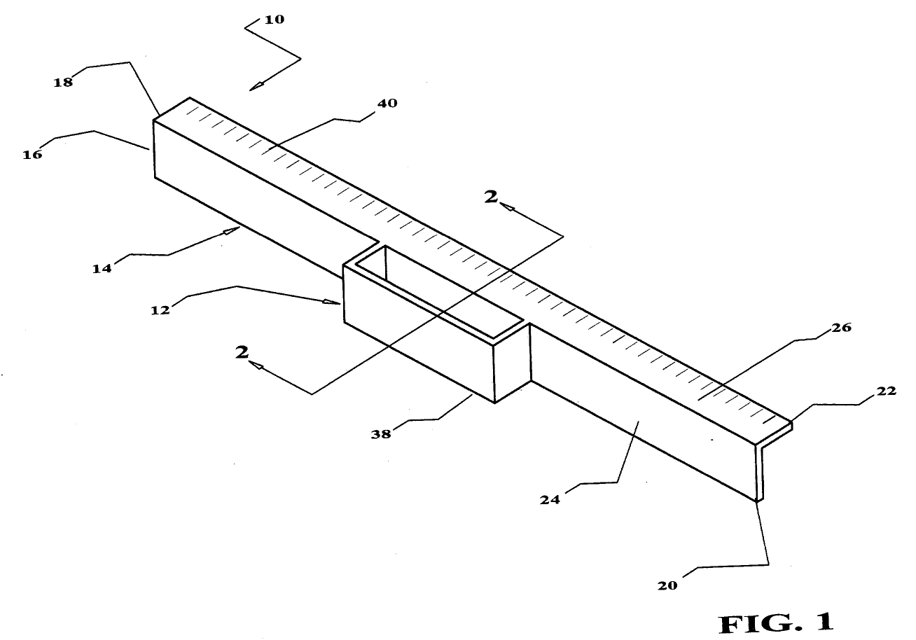

FIG. 1 shows a representative drawing tool 10 that I constructed by attaching a U-shaped handle 12 to a foot-long piece of angle bar 14 made from transparent plastic stock. The angle bar 14 has first and second legs 16, 18 with parallel edges 20, 22 and outer faces 24, 26 that form a dihedral angle greater than 180°. The handle 12 is attached to the first outer face 24.

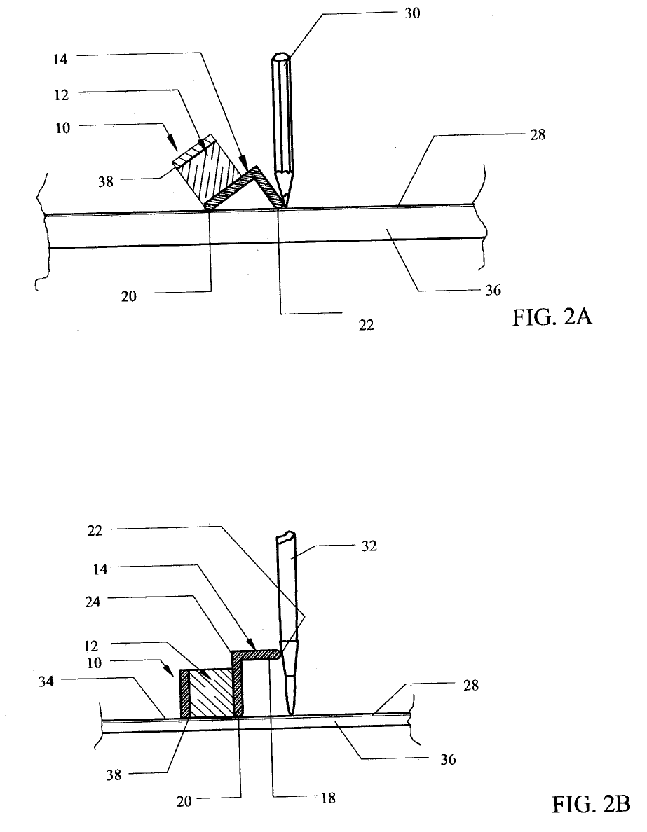

Operations of the drawing tool 10 are straightforward. FIG. 2A shows the tool 10 in position to be used as a ruler with both the first and second edges 20, 22 in contact with a sheet of paper 28. The user holds the tool 10 by the handle 12 and draws a line with, for example, a pencil 30 along the second edge 22.

FIG. 2B shows the tool 10 rotated onto the first edge 20, with the second edge 22 elevated above the paper 28. A line can then be drawn with a watery medium such as watercolor or ink with a brush 32 using the elevated second edge 22 as a guide while preventing the medium from smearing or wicking under the first edge 20 onto the paper 28. In this manner the tool 10 provides a stable platform for drawing lines with a watery medium particularly when, as shown here, the handle 12 and the first edge 20 are disposed in a plane 34 that is parallel to the writing surface 36 and is perpendicular to the second edge 22. Thus, if the angle bar 14 is made from right-angle stock, the first edge 20 and the base 38 of the handle 12 opposite the first edge 20 are disposed in a plane perpendicular to the first outer face 24. Such a self-supporting configuration prevents the second edge 22 from toppling onto the paper 28 if the tool 10 is accidentally released. The angle bar 14 may have a length of one foot, one yard or meter, or other convenient length. The width(s) of the legs 16, 18 may be varied to accommodate different drawing implements, such as different size paintbrushes. The second edge 22 may bear indicia 40 of measurement units such as inches and centimeters. The angle bar 14 is preferably but not necessarily constructed of right-angle stock, in which case the dihedral angle between the outer faces 24, 26 will be approximately 270°. The angle bar 14 is preferably but not necessarily straight, as for certain drafting (but not painting) applications the first and second edges 20, 22 may be curved in parallel.

The handle 12 may be configured in various shapes to provide a convenient manipulable surface so that the drawing tool 10 can be held, positioned, and lifted without having to slide the drawing tool 10 off of the paper 28. The handle 12 also minimizes finger smudging, as the hand does not contact the second edge 22 where excess drawing medium may have been deposited. The handle 12 is preferably attached approximately midway along the first outer face 22 of the angle bar 14, as this configuration is conveniently manipulated with either hand.

The drawing tool 10 may be constructed by attaching the handle 12 to the angle bar 14 with adhesive, welding or mechanical means. Transparent plastic is preferred but wood or metal may be used. Alternatively, the drawing tool 10 may be formed as a unitary plastic extrusion.

I claim:

1. A drawing tool comprising an angle bar and handle, wherein the angle bar has first and second legs having parallel edges and outer faces forming a dihedral angle greater than 180°, and wherein the handle is attached to the first outer face.

2. The drawing tool of claim 1, wherein the angle bar is straight.

3. The drawing tool of claim 1, wherein the dihedral angle is 270°.

4. The drawing tool of claim 1, wherein the handle is attached midway along the first outer face.

5. The drawing tool of claim 1, wherein the handle and the first edge are disposed in a plane that is perpendicular to the second edge.

6. The drawing tool of claim 1, wherein the second leg bears graduated indicia.

7. The drawing tool of claim 1, wherein the angle bar and handle are composed of a transparent material.
